(19) United States
(12) Patent Application Publication
(10) Pub. No.: US 2005/0103437 A1
(43) Pub. Date: May 19, 2005

(54) Seaming iron with automatic traction

(76) Inventor: James M. Carroll, Livermore, CA (US)

Correspondence Address: BRIAN M BERLINER, ESQ;O'MELVENY & MYERS, LLP, 400 SOUTH HOPE STREET, LOS ANGELES, CA, 90071-2899, US

(21) Appl. No.: 10/718,446

(22) Filed: Nov. 19, 2003

(51) Int. Cl. B29C 65/00; E04D 15/00

(52) U.S. Cl. 156/304.4; 156/574

(57) ABSTRACT

A carpet seaming iron is coupled with a tractor so that the seaming iron can be automatically moved along a seam line. The tractor is driven by a motor. Motor speed may be controlled in various ways, including by user input from a control panel or by determining an optimal speed based in signals from a temperature sensor.

### BACKGROUND OF THE INVENTION

1. Field of the Invention

The present invention relates to making seams in carpets using a heat-activated adhesive tape disposed along the carpet seam, and an adhesive activation tool (herein called a “seaming iron”) to heat the tape. More particularly, the invention provides a seaming iron with automatic traction for moving the iron or tool along the heat-activated adhesive tape at a controlled speed during the seaming process, and method of seaming thereby.

2. Description of Related Art

There exists on the market today a wide variety of heat-activated adhesive tapes and carpet seaming irons. Typically, the tape is placed underneath the two pieces of carpet being joined together and centered on the intended seam. The seaming iron is placed under the carpet but on top of the heat-activated adhesive so that it is in direct contact with the adhesive. Other seaming irons have a base portion with an insulated bottom with a heating “tunnel” through which the heat-activated adhesive tape is passed. The adhesive tape is enclosed in the heating “tunnel” but is not in direct contact with the adhesive. The iron heats the adhesive and is then moved by hand along the length of the seam approximately six to eight inches. This provides room for the carpet to drop down and make contact with the heated adhesive. A roller is usually used to roll or press the carpet into the heated adhesive. The installer then advances a seam weight to the area of the carpet just rolled or pressed in order to hold the seam flat while the adhesive cools. When the adhesive cools, the seam is held together by the tape and hardened adhesive.

A newer method of heating the tape uses an induction tool. An induced magnetic field creates heat in a metal-foil layer positioned under the heat-activated adhesive. This foil transfers heat to the adhesive. In this case the induction seaming iron is not in direct contact with the adhesive, but the end result is the same as achieved by more traditional seaming irons: the adhesive is melted. The tool is then moved by hand to the next heating position and the carpet is rolled into the adhesive.

Other types of hand-advanced seaming irons may also have been used commercially or experimentally. For example, a seaming iron may comprise a flat plate, skid heater or other suitable heating element that is placed underneath conventional carpet seaming tape, heating the non-adhesive paper backing of the tape which transfers heat to the adhesive. This type of iron may additionally include a heating tunnel or tunnel-like support for a handle disposed over the tape. In the alternative, it may be dragged under the carpet using a line in a manner similar to a seaming board. For further example, a seaming iron may comprise a hand-held pair or set of electrodes for heating adhesive on a conductive backing by electrical resistance through the backing. All of these types of seaming irons may also be advanced by hand before the carpet is rolled into the adhesive.

Regardless of which of the above types of seaming iron is employed, the sequence of events is the same. The seaming iron melts the adhesive, and then the seaming iron is manually moved a discrete distance to allow the carpet to be rolled or pressed down into the adhesive. Thus, prior-art seaming irons and methods for using them are subject to several limitations, which are described below.

First, when using prior-art seaming irons, an installer must take time to move the seaming iron, reducing the time available to adjust the carpet edges while the adhesive is still in a molten state. Often, some adjustment is needed after the adhesive is activated, to ensure an inconspicuous seam. For example, lateral adjustment, which includes shifting the two pieces of carpet along the length of the seam to insure any pattern woven into the carpet is matched between these two pieces of carpet, may be needed. Another adjustment is drawing the carpet edges together so as to abut one another, with no gap or overlaps between the edges. The carpet edges may also need to be vertical aligned, to ensure that the top of the carpet is smooth.

Skillful positioning of the carpet can be very important to achieving a good result. If the carpet seam is not skillfully completed, the customer will often complain, necessitating an expensive return visit to repair the problem. This is not an isolated problem. In the carpet industry, customer complaints make up a significant part of the carpet cost. The single largest type of complaint, approximately 70%, arises over improperly made or unsightly seams. But prior-art irons allow very little time for adjustment of the seam, making the skill and attention of individual installers all the more critical. It would be desirable to make a seaming iron that provided additional time for seam adjustment and was easier to use.

Another problem with prior-art seaming irons is that, when left in one position for too long, excess heat from the iron may distort, or even melt, the carpet backing material. In addition, the adhesive may overheat and lose too much viscosity, seeping through the tape or around it. This may cause the carpet to adhere to the padding underneath, and decrease the amount of adhesive available to make the seam. In addition, overheating the adhesive may produce excessive smoke, and/or degrade the adhesive itself. It is desirable, therefore, to provide a system and method for reducing or eliminating the risk of overheating the carpet or adhesive.

A still further problem with prior-art seaming irons, and in particular, those that do not make direct contact with the adhesive, is that it may be difficult to determine when the adhesive is adequately heated. If the seaming iron is advanced too quickly, the adhesive may not be sufficiently softened, and will not bond securely to the carpet backing. On the other hand, if the seaming iron is moved too slowly, the adhesive may become overheated. In addition, the seaming process may be unnecessarily slowed. It is further desirable, therefore, to provide a system and method for ensuring an optimal degree of adhesive activation and an optimal seaming speed.

### SUMMARY OF THE INVENTION

The invention provides a seaming iron, and method for using it, that overcomes the limitations of the prior art. In an embodiment of the invention, a seaming iron is equipped with an automatic traction system. The traction system may be operated so as to drive the seaming iron along the seam at a desired speed. The automatic traction system may comprise a motor connected to a plurality of drive wheels, that are configured to drive the seaming iron over the top surface of the carpet. In the alternative, the automatic traction system may comprise a winch and cable system placed at one end of the seam. The cable is attached to the carpet seaming iron or tool. The winch automatically draws or drags the iron or tool along the seam toward the winch at a desired speed during the seaming process.

The seaming iron with automatic traction may further comprise electronic controls that allow the speed to be adjusted or changed to match heat rate with seam speed, or to slow the process to allow an installer to take more time if the seam is becoming difficult. Remote and/or local controls can be built by one of ordinary skill in the art, using the wide variety of technologies existing today.

Advantageously, automatic movement of the seaming iron at a controlled speed achieves a uniform application of heat to the adhesive, consistently producing a superior seam. The automated process eliminates heating gaps and unnecessary reheating, and increases the speed of the seaming process. The installer is allowed greater time to focus on making a perfect seam. Any one of these advantages represents an improvement over the prior art; together they represent a significant stride forward.

### BRIEF DESCRIPTION OF THE DRAWINGS

FIG. 1 is a perspective view of an exemplary seaming iron with automatic traction, in position over a carpet seam.

FIG. 2 is a perspective view of an exemplary seaming iron with automatic traction over a carpet seam, of an alternative type employing a line and winch mechanism.

FIG. 3 is a diagram of a seam along a seam line, with an exemplary seaming iron and traction system according to the invention.

FIG. 4 is a diagram of a seam along a seam line, with an exemplary seaming iron and traction system according to an alternative embodiment of the invention.

FIG. 5 is a perspective view of an exemplary seaming iron and tractor drive according to an exemplary embodiment having an integrated housing.

FIG. 6 is a block diagram of an exemplary system comprising a seaming iron and tractor.

FIG. 7 is a flow diagram showing exemplary steps of a method according to the invention.

### DETAILED DESCRIPTION OF THE PREFERRED EMBODIMENT

The present invention provides a seaming iron with automatic traction, and method for seaming thereby, that overcomes the limitations of the prior art. In the detailed description that follows, like element numerals are used to denote like elements appearing in one or more of the figures.

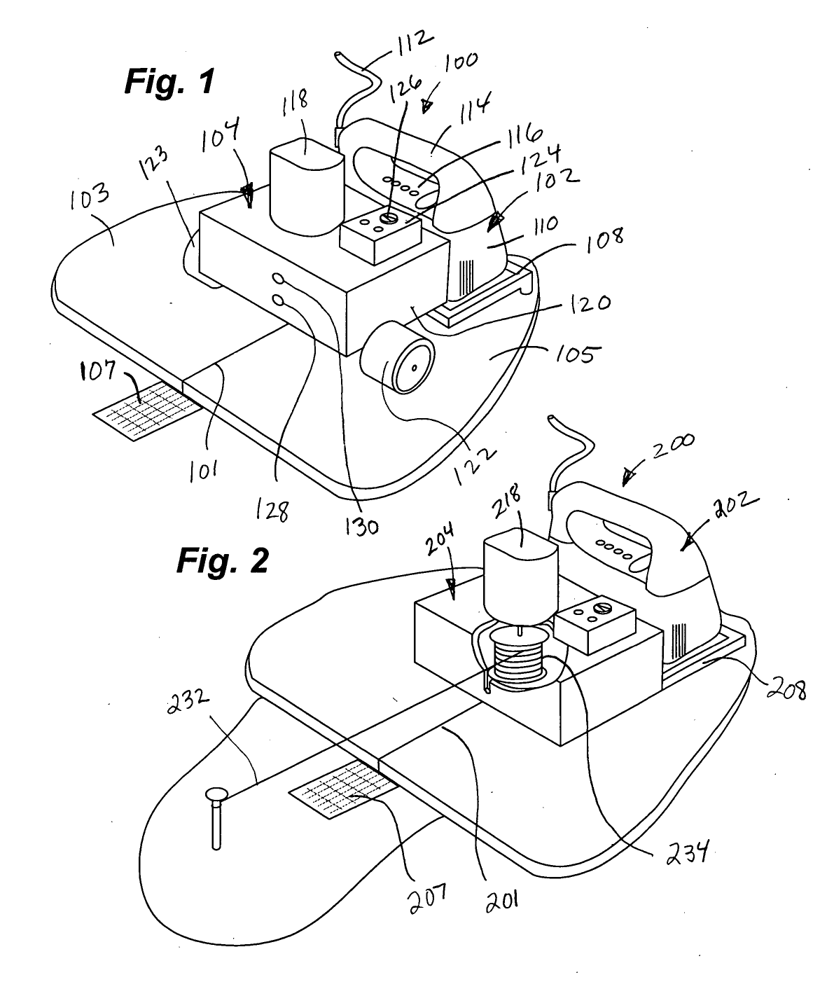

FIG. 1 shows an exemplary automatic traction seaming system 100 comprising a seaming iron 102 and a tractor 104. System 100 is positioned over adjacent carpet pieces 103, 105 at their abutting edges forming a carpet seam 101. Carpet seam 101 is to be bonded together using heat-activated tape 107 that is positioned under carpet pieces 103, 105 along the length of seam 101. Adhesive on tape 107 is activated by heat that is supplied to it by seaming iron 102.

In the depicted embodiment, iron 102 comprises an induction-heating tool that supplies heat by inducing an electric current in a foil or other conductive layer in tape 107. An induction heating iron 102 may be operated entirely from the upper surface of pieces 103, 105, and need not make contact with tape 107. When so configured, it may be difficult for a user to determine when tape 107 is sufficiently heated, because the heated portion of the tape is obscured by the overlying carpet, and there is no tactile feedback as the adhesive melts, unlike a conventional seaming iron. Tractor 104 is therefore believed especially advantageous for non-contact seaming irons such as those that use inductive heating, but may also be used with conventional seaming irons, and any other suitable seaming iron. Seaming iron 102 may further comprise an electrical cord 112 for supplying power to the iron and/or to tractor 104, a handle 114 to permit manual handling of the iron, and a control panel 116. The invention is not limited to any particular configuration of seaming iron.

Tractor 104 is connected to seaming iron 102 via a frame 108 configured to retain the seaming iron in a position suitable for activating a section of tape 107 under carpet pieces 103, 105. In the depicted embodiment, frame 108 is configured as a tray into which seaming iron 102 may readily be placed and removed. Frame 108 may be integrated into housing 120 of tractor 104. Advantageously, this ease with which tractor 104 may be connected to seaming iron 102 permits a user to easily remove the seaming iron when needed. For example, tractor 104 may not be needed or may obstruct the seaming iron when forming very short seams or at the end of a seam. Frame 108 may be configured in any other suitable manner, for example, as a connection bracket, a tension link, or as an integral part of the housing 110 of seaming iron 102. In the illustrated embodiment, frame 108 rests directly on the carpet surface. In the alternative, frame 108 may be supported over the carpet surface by a wheel or other rolling element, or by seaming iron 102 itself.

Tractor 104 comprises a rotary motor 118 connected to frame 108. In the illustrated embodiment, motor 118 is connected to frame 108 by mounting to a housing 120 of tractor 104, to which frame 108 is also mounted. Any other suitable connection may be used. It is not necessary that the motor be mounted to a movable part. For example, motor 118 may be fixed to the wall or floor ahead of the iron, and pull tractor 104 along seam 101 by winding up a flexible cable attached to the tractor. In whatever manner that a connection is made, it should be configured so that driving the motor at a predetermined speed and direction causes the frame 108 to advance along seam 101 at a rate suitable for activating the seaming tape 107 when iron 102 is operating. One of ordinary skill may devise various suitable connections. Motor 118 may comprise any suitable motor for imparting rotational motion to a shaft. For example, motor 118 may comprise an alternating current motor, a direct current motor, an air motor, or a hydraulic motor.

Motor 118 may be used to drive one or more wheels 122, 123 that provide traction to move system 100 along seam 101. In the depicted embodiment of the invention, wheels 122, 123 comprise relatively long cylinders covered with a layer of relatively high-friction material, such as a soft rubber or rubber-like polymer. In the alternative, wheels 122, 123 may be relatively hard and covered with pins, spikes, or any other suitable gripping elements for engaging a tufted carpet surface. Any number of wheels may be used; for example, two, three, or four. Wheels 122, 123 may be replaced by any suitable traction element, for example, a tractor belt drive or mechanical legs. Motor 118 may be linked to the traction elements, such as to wheels 122, 123, by any suitable linkage. For example, rotational motion may be transmitted to the drive wheels using a gear train and/or a belt drive.

Tractor 104 may comprise a control panel 124, including a speed adjustment knob 126 whereby a user may provide input for controlling the speed of motor 118, and hence, the rate of advance of system 100 along seam 101. The control panel may also include an on/off switch, an indicator light, and any other desired element for providing information or control to a user. Control panel 124 may comprise a remote-control device that need not be attached to tractor 104.

Tractor 104 may further comprise an alignment sensor 128 and a steering mechanism that together comprise a guidance system for keeping system 100 on track as it moves along a seam. Of course, movement of the tractor is fairly slow and tractor 104 may track in a straight line fairly well without any guidance. Most carpet seams are also made in straight lines, so it may be desirable to omit a guidance system altogether. But if a guidance system is provided, a wide variety of configurations is possible. For example, alignment sensor 128 may comprise a beam follower that measures the position of a beam of incident radiation, for example, infrared, ultraviolet, visible light, laser light, or radio frequency. A radiation source may be placed at the end of the seam line to provide a guide beam along the seam line 101. In the alternative, a source 130 may be placed on tractor 104 to emit a beam that is reflected off of a mirror or other object placed at the end of the seam.

Any suitable alignment sensor may be used. Other alternatives for alignment sensors include a sensor that detects a material placed under the seam line. For example, an electronic or magnetic sensor may be used to detect a wire placed along the seam. If this type of sensor is used, placement of the material detected by the alignment sensor may be conveniently accomplished by incorporating it into seaming tape 107. For example, a magnetic ink could be printed down the center line of a paper backing for the tape, and the alignment sensor would detect the presence of the ink stripe. Yet another alternative is to use a mechanical contact sensor. For example, a pin, blade, or other “feeler” could be configured to protrude from tractor 104 into seam 101 between the adjacent piece of carpet. If the tractor strays from the seam, the feeler may either bend, rotate, or be subjected to measurable stresses, any of which may be detected and used to provide a guidance signal.

A guidance signal from the alignment sensor may be provided to a controller that may be housed in the control panel 124 or inside housing 120. The controller may process the guidance signal to drive a steering system for tractor 104. Any suitable steering system may be used. For example, wheels 122, 123 may be configured so that they can rotate independently and be driven at different speeds or in different directions. The tractor may then be steered by controlling the relative rotational speed and/or direction of the opposing wheels. A similar result may be achieved by using a central drive wheel and braking an appropriate one of opposing outlying idler wheels to steer. Yet another alternative is to provide a mechanical linkage for turning the wheels, similar to what is used for motor vehicles.

In an alternative embodiment, traction may also be supplied to seaming iron/tractor system 200 via a winching system, such as comprising an anchored flexible cable 232 and a reel 234, as shown in FIG. 2. System 200 is depicted with the same type of seaming iron 202 as used in system 100, but any other suitable seaming iron may also be used. Seaming iron 202 is retained in a position for activating tape 207 along seam line 201 by frame 208, which is attached to tractor 204. Tractor 204 comprises a motor 218 that is connected to drive a reel 234. Driving motor 218 at a predetermined speed and direction causes cable 232 to be wound up on reel 234, pulling tractor 204 and its attached seaming iron 202 along seam line 201. A free end of cable 232 may be anchored at a destination end of the seam line. In the alternative, motor 218 and reel 234 may be anchored at the destination end of the seam, and the free end of cable 232 connected to frame 208. Either way, passive guide wheels, blades, or rails (not shown) may be provided underneath tractor 204. Such guide structures may be configured to freely permit forward movement of tractor 204, while resisting lateral movement. Such guides may thereby reduce yawing of tractor 204 around the center of attachment of cable 232, and keep movement of tractor 204 aligned with seam line 201.

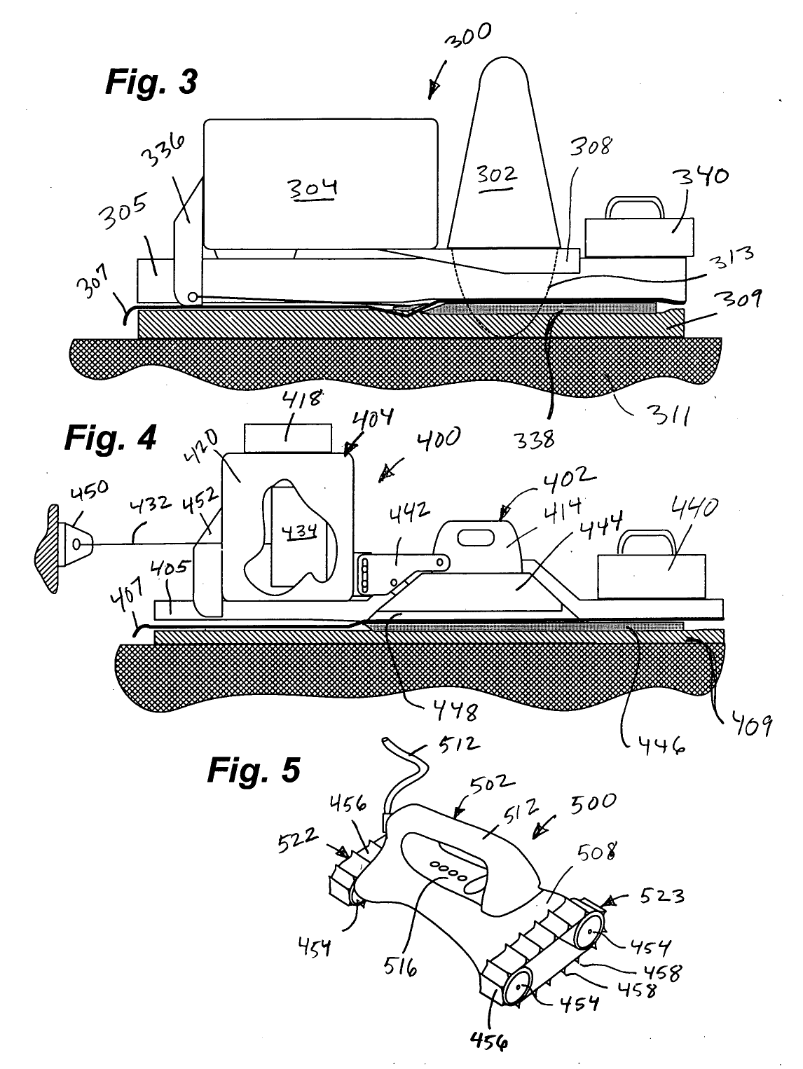

FIG. 3 shows a side view of a carpet 305 and related materials along a seam line, with an exemplary seaming iron and traction system 300. The drawing is not to scale, and the thickness of carpet 305 is particularly exaggerated for clarity. Seaming tape 307 is positioned under and spanning adjacent carpet pieces, only one of which (i.e., carpet 305) is shown. A piece of padding material 309 underlies carpet 305, and rests on floor 311. Induction seaming iron 302 rests on a tray or frame 308, which is attached to a tractor 304, which is of any suitable type described hereinabove. A tow bar 336 is attached to tractor 304, and extends between adjacent carpet pieces at the seam. A backing board 338, sometimes called a “seam board,” may be interposed between pad 309 and carpet 305 rearward of seaming iron 302. The backing board may be connected to tow bar 336 by a cable or line, and, thus, towed along the seam by tractor 304 with seaming iron 302.

Backing board 338 may comprise a relatively thin, relatively rigid material; for example, a thin piece of plywood, a piece of flat plastic stock or reinforced plastic material. To reduce friction, board 338 may be coated with any suitable low-friction material, for example a silicone or polytetrafluoroethylene material. Board 338 may be used to support the carpet seam in the area where the tape 307 adhesive is melted or soft, to promote alignment of the carpet edges and wetting of the carpet backing by the tape adhesive. A seam weight 340 may be positioned on the carpet 305 over seam board 338, to hold the carpet onto the tape 307 until the tape adhesive hardens. Any suitable seam weight may be used, as known in the art. In addition, seam weight 340 may be connected to tractor 304 and towed behind iron 302, if desired.

Dotted line 313 illustrates an outer boundary for a heating zone from induction seaming iron 302. A section of tape 307 inside of this zone is heated by energy from the seaming iron 302 until its adhesive is suitably melted or softened. Rearward of this zone, a user positions the carpet in the softened adhesive and holds it in place until the tape adhesive hardens.

FIG. 4 provides a similar side view of a seam line, illustrating one of the alternative embodiments of the invention that have already been described. A tractor system 400 comprises a winch-type tractor 404 towing a tunnel-type seaming iron 402 using a floating link 442. Link 442 exemplifies a frame, or a portion of a frame, for connecting a tractor drive to seaming iron 402, thereby retaining it in a position for activating seaming tape 407 under the seam. Link 442 may be configured to allow iron 402 to float vertically, while preventing rotation of iron 402 about its pitch, yaw, and/or roll axes. Iron 402 comprises a handle 414, a heat shield 444 connected to the handle, a base 446 that rests on pad 409, and a heating tunnel 448 between the base and the heat shield, through which tape 407 may be threaded. Base 446 may be extended rearward of the heat shield 444, to support the seam while the tape 407 adhesive is still soft. In addition, or in the alternative, a separate seam board may be used. A seam weight 440 may be manually moved behind seaming iron 402, or towed by tractor 404.

Tractor 404 may comprise a housing 420 configured to slide over a top surface of carpet 405. A motor 418 may be mounted to housing 420, and connected to a reel 434 for winding flexible line 432, thereby towing system 400 along the seam line. An opposite end of line 432 may be anchored at one end of the seam line using any suitable anchor 450. Tractor 404 may further comprise a guide blade 452 protruding between the adjacent pieces of carpet into the seam line. Guide blade 452 may comprise a portion of any suitable guide system as previously described.

To operate system 400, a user may position the system at a first end of the seam, unwind line 432 from reel 434, and anchor the free end of the line at the opposite end of the seam. Iron 402 is powered on, and after it becomes suitably warmed, motor 418 is started and begins moving system 400 along the seam line by winding line 432 onto reel 434. As iron 402 is drawn along the seam, tape 407 moves through tunnel 448, where it is warmed by a heating element placed under heat shield 444 and/or in base 446. Carpet 405 passes over heat shield 444, and handle 414 may protrude through the abutting carpet edges. Adhesive on a section of tape 407 becomes activated by this heating, and is ready for use as it exits tunnel 448. Heat shield 444 may be contoured to guide carpet 405 onto tape 407, as the tape exits tunnel 448. The adjoining carpet edges may then be positioned onto the activated and softened adhesive rearward of iron 402, and held in place using a seam weight 440 while the tape adhesive hardens.

It should be apparent that system 400 may be similarly configured using a conventional carpet seaming iron (not shown), instead of tunnel-type iron 402. To do so, the conventional iron may be placed in the same position as shown for iron 402, but with the heating platen (i.e., base) of the conventional iron resting on top of tape 407, instead of threading the tape 407 through tunnel 448. Operation of system 400 will otherwise be essentially unchanged.

In an embodiment of the invention, a motor and drive elements are incorporated into the same housing as a seaming iron, instead of being located in a separate tractor. FIG. 5 shows an exemplary seaming iron and tractor drive 500, according to an exemplary embodiment having an integrated housing 508. Housing 508 comprises a frame that connects an internally mounted motor and its associated drive elements 522, 523 to a seaming iron 502. In an embodiment of the invention, seaming iron 502 may be of an inductive-heating type, and may comprise an inductive-heating element mounted inside housing 508, a handle 512, a power cord 512, and a control panel 516. In other embodiments, other types of seaming irons, including but not limited to conventional seaming irons, may be integrated into a housing with a motor and drive element.

In an embodiment of the invention, drive elements 523, 522 may comprise a plurality of wheels 454 for driving belts 456. Belts 456 may comprise a relatively soft yet strong material with a relatively high friction coefficient, such as a polymer-covered fabric belt, or a durable rubber or other flexible polymer material. The belts may be provided with a plurality of gripping elements 458 for improving traction on the carpet surface. In the alternative to wheels 454 and belts 456, any other suitable drive element may used, including but not limited to wheels or winches.

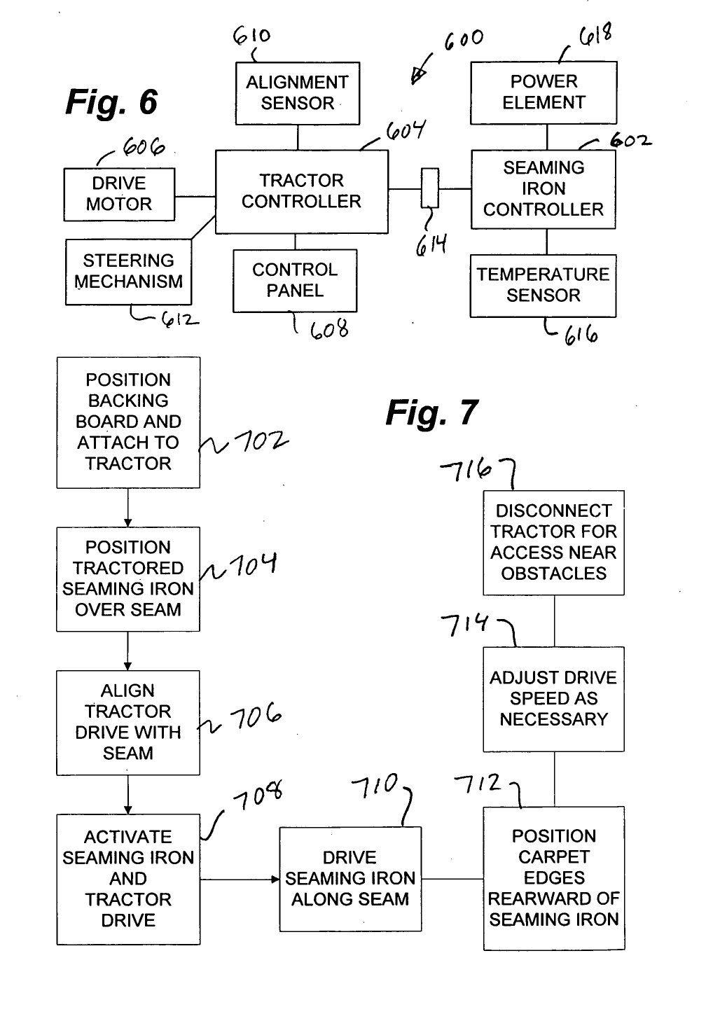

FIG. 6 shows an exemplary control system 600 for use with a seaming iron and tractor according to the invention. Control system 600 comprises a tractor controller 604 connected to control a drive motor 606. Controller 604 may comprise any suitable electronic controller as known in the art. Controller 604 may be programmed to provide a control signal to motor 606, whereby motor 606 operates at a desired speed and direction. Controller 604 may also be connected to a steering mechanism 612. As previously described, a steering mechanism may include motor 606, or in the alternative, may be entirely separate. Controller 604 may be configured to send a control signal to the steering mechanism, whereby travel of the tractor may be maintained in a desired direction.

Controller 604 may further be connected to an alignment sensor 610, such as any of the sensor types already described. Controller 604 may process signals from the alignment sensor, and output a control signal to the steering mechanism and/or drive motor to maintain a desired direction of travel. Controller 604 may further be connected to a control panel 608 for providing user input. Controller 604 may process input signals indicating a desired speed or direction of travel, and output appropriate control signals to the drive motor and/or steering mechanism.

Controller 604 may also receive signals from components more closely associated with the seaming iron, either directly, or indirectly through a separate seaming iron controller 602. For example, signals indicative of adhesive or iron temperature may be received from a temperature sensor 616. These temperature signals may then be used by either or both controllers 604 to determine an appropriate speed for motor 606. In addition, or in the alternative, temperature signals may be used for control of the power element 618 of the seaming iron. For example, electric power supplied to the power element may be attenuated, such as by using a PWM scheme. Yet another possibility enabled by system 600 is to control the power supplied to the heating element based on a speed setting of the motor. For example, if a user changes the tractor speed, controller 602 may sense the change in speed and modulate power supplied to the heating element. Any of the foregoing embodiments, or any combination of them, may effectively reduce or eliminate the possibility of overheating or underheating the seam, thus overcoming a limitation of the prior art.

For seaming iron systems that comprise a removable tractor, it may be advantageous to provide a removable connector 614 between components of system 600 located in the tractor, and those located in the seaming iron. For ease of connection and removal, connector 614 may be configured as part of a cradle by which an electrical connection can be made merely by placing a suitably configured seaming iron into the cradle. One of ordinary skill may devise various different ways to implement a control system 600.

FIG. 7 shows exemplary steps of a method 700 for seaming carpet, which may be implemented using embodiments described above. Optionally, at step 702, a backing board may be placed under adjacent areas of carpet to be seamed at the seam line, as known in the art. Typically, the backing board rests on top of the carpet pad and underneath the seaming tape. A line may be attached to the backing board and run in advance of the seam line so as to permit the backing board to be pulled along the seam under the tape, without disturbing the position of the tape. This line may be attached to a tractor as described herein.

At step 704, a seaming iron with automatic traction system as described herein may be positioned at a first end of the seam line. Prior to positioning the seaming iron, a length of heat-activated seaming tape may be positioned along and under the seam line defined by the opposing edges of the pieces of carpet to be seamed. The seaming may then be positioned over the seam line so that its heating element is disposed to activate an end section of seaming tape. At step 706, the tractor is aligned with the seam line so that it will move the seaming iron along the seam when powered on.

At step 708, the seaming iron may be powered on so that its heating element begins to activate the seaming tape. When starting cold, some delay may be provided to allow the end section of tape to be fully activated, before setting the tractor in motion. In the alternative, the seaming iron may be pre-heated, and forward movement may start almost immediately after placing the seaming iron on the seam.

At step 710, forward movement of the tractor and seaming iron continues along the seam. As indicated at step 712, during this forward movement, a user may position the opposing edges of the carpet in the activated seaming tape rearward of the seaming iron, following the seaming iron as it automatically moves along the seam line. Finishing the seam behind the iron may be carried out in a manner similar to conventional seaming, with the important difference that finishing may be performed continuously without a need to reposition the seaming iron. At step 714, a user may adjust the speed of automatic movement, such as by using a control panel on the tractor to speed up or slow down the forward movement. Changes in speed may be automatically compensated for by reducing power to the heating element, if desired. In the alternative, heating power may be held fixed.

At times, depending on the type of tractor being used, the tractor may itself interfere with the progress of the seaming iron along the seam. This may occur, for example, when finishing a seam that ends near a wall. Accordingly, step 716 shows that the tractor may be decoupled from the seaming iron, and a section of the seam formed manually, in those areas where the tractor would interfere with the progress of the iron.

It should be apparent to those skilled in the art that certain advantages of the within system have been achieved. It should also be appreciated that various modifications, adaptations, and alternative embodiments thereof may be made within the scope and spirit of the present invention. For example, a tractor drive has been illustrated in front of a seaming iron, but it should be apparent that the inventive concepts described above would be equally applicable to a tractor drive placed above, behind, or next to the heating iron, or one that is integrated into the same housing as a seaming iron. It should also be apparent that the term “seaming iron” as used herein includes every type of portable tool that is configured to activate a seaming tape while being moved along the length of a seam, and is not limited to what may otherwise be understood by those of ordinary skill in the art. The invention is defined by the following claims.

1. A tractor mechanism for automatically moving a seaming iron along a carpet seam, the tractor mechanism comprising:
a frame configured to retain a seaming iron in a position suitable for seaming adjacent pieces of carpet along a carpet seam; and
a motor connected to the frame, whereby driving the motor at a predetermined speed and direction causes the frame to advance along the carpet seam at a rate suitable for activating a seaming tape under the carpet seam when the frame is retaining an operating seaming iron.

2. The tractor mechanism of claim 1, further comprising at least one drive wheel connected to the motor.

3. The tractor mechanism of claim 2, wherein the at least one drive wheel comprises a wheel configured to engage a tufted carpet surface.

4. The tractor mechanism of claim 1, further comprising a seaming iron retained by the frame.

5. The tractor mechanism of claim 4, further comprising a detachable connection between the frame and the seaming iron.

6. The tractor mechanism of claim 4, further comprising a detachable electrical connector disposed to connect the seaming iron to a control unit for the motor.

7. The tractor mechanism of claim 4, wherein the frame comprises an integrated housing for the seaming iron and the motor.

8. The tractor mechanism of claim 4, wherein the seaming iron is selected from the group consisting of an induction heating tool and a resistive heating tool.

9. The tractor mechanism of claim 1, wherein the frame comprises a bracket for attaching to a flexible line.

10. The tractor mechanism of claim 1, further comprising a reel for winding a flexible line connected to the motor, whereby the frame may be pulled along the carpet seam by the line.

11. The tractor mechanism of claim 1, wherein the frame comprises a tray configured to receive a seaming iron.

12. The tractor mechanism of claim 1, further comprising a seaming board for placing underneath the carpet seam connected to the motor, whereby driving the motor at a predetermined speed and direction causes the seaming board to advance along the carpet seam at the rate of the frame.

13. The tractor mechanism of claim 1, wherein the motor is configured to operate at a fixed speed.

14. The tractor mechanism of claim 1, wherein the motor is configured to operate at an adjustable speed determined from a user input.

15. The tractor mechanism of claim 1, further comprising a motor controller connected to control the motor.

16. The tractor mechanism of claim 14, further comprising a temperature sensor connected to the motor controller, whereby the motor is controlled to operate at a speed determined from a temperature measured by the temperature sensor.

17. The tractor mechanism of claim 14, further comprising an indicator of power supplied to a heating element of a seaming iron, wherein the motor controller is connected to determine a value of the indicator, whereby the motor is controlled to operate at a speed determined from the value of the indicator.

18. The tractor mechanism of claim 1, further comprising a seaming weight connected to the motor, whereby driving the motor at a predetermined speed and direction causes the seaming board to advance along the carpet seam at the rate of the frame.

19. The tractor mechanism of claim 1, further comprising an alignment sensor connected to control a steering mechanism for the frame.

20. The tractor mechanism of claim 19, wherein the alignment sensor comprises a protrusion projecting from the tractor mechanism between the adjacent pieces of carpet at the seam.

21. The tractor mechanism of claim 19, wherein the alignment sensor comprises a beam detector in combination with a beam source, the beam source selected from the group consisting of an ultrasound source, a radio source, an ultraviolet source, a visible light source, an infrared source, and a laser source.

22. The tractor mechanism of claim 19, wherein the alignment sensor is configured to sense at least a component of the seaming tape.

23. A method for seaming adjacent pieces of carpet, the method comprising:
positioning a length of heat-activated seaming tape along and under a seam line defined by opposing edges of adjacent pieces of carpet;
positioning a seaming iron over the seam line, the seaming iron having a heat-activating element disposed to activate a section of adhesive tape; and
automatically driving the seaming iron at a predetermined rate along the seam line by a motor, while the seaming iron is operating.

24. The method of claim 23, wherein the automatically driving step further comprises driving the seaming iron at a constant speed.

25. The method of claim 23, wherein the automatically driving step further comprises driving the seaming iron at an adjustable speed.

26. The method of claim 23, further comprising automatically guiding the seaming iron along the seam line.
